(19) United States
(12) Patent Application Publication
(10) Pub. No.: US 2004/0237499 A1
(43) Pub. Date: Dec. 2, 2004

(54) Closed loop energy system for power generation and transportation based on metal fuel and condensed phase oxidizer

(76) Inventors: Amnon Yogev, Rehovot (IL); Eliyahu Gamzon, Beit Oved (IL)

Correspondence Address: Gary M. Nath, NATH & ASSOCIATES PLLC, 6th Floor, 1030 15th Street, N.W., Washington, DC, 20005, US

(21) Appl. No.: 10/889,166

(22) Filed: Jul. 13, 2004

Related U.S. Application Data
(63) Continuation-in-part of application No. PCT/IL03/00234, filed on Mar. 18, 2003.
(60) Provisional application No. 60/364,624, filed on Mar. 18, 2002.

(51) Int. Cl. F02G 1/00

(52) U.S. Cl. 60/39.6

(57) ABSTRACT

The present invention suggests a safe process and system for generating energy, which may be used for transportation applications such as car propulsion. More particularly, the process of the invention is for producing mechanical work from heat generated by at least one exothermic chemical reaction. In each step of the process, at least part of the heat is generated by a process comprising introducing into a reaction chamber a metal from a metal reservoir and an oxidizer from an oxidizer reservoir. The metal and the oxidizer used in this process are of kinds that react exothermally with each other, and the oxidizer is oxygen of ambient air or is of a condensed phase origin.

### FIELD OF THE INVENTION

This invention relates to processes for producing mechanical work from an exothermic chemical reaction involving a metallic fuel.

### BACKGROUND OF THE INVENTION

There is a worldwide effort to find substitution to fossil energy sources due to environmental reasons or security of supply. Most power systems, either renewable or nuclear, provide solutions for electricity production, but to date, there is no satisfactory substitute for liquid fuel for use in transportation (cars, airplanes, and the like). Also, there is no satisfactory solution to the storage requirements posed by the intermittent nature of most of the renewable energy sources.

The most common approach to this problem is to use hydrogen as fuel. Hydrogen can be easily produced by electric energy from water, and then oxidized either in traditional thermal machines or in fuel cells. The last concept is usually considered in the art to be the preferred solution.

The most sever problem in the application of hydrogen technology is the handling of hydrogen. Hydrogen is a gas and for most applications it has to be either compressed or liquefied. Another problem is the explosive nature of hydrogen. Hydrogen molecule is very small and has very high diffusion coefficient, and tends to leek from very tiny holes. All these factors lead to complicated and heavy equipment that has prevented widespread use of the various hydrogen technologies.

Hydrogen peroxide is known in the art as an oxidizer in propulsion systems, where either it is used to exothermally dissociate to form heat or as an oxidizer of conventional fuels.

Hydrogen is known as an electrolytically obtained fuel in propulsion systems. However, in most of these systems some problems of safety, distribution and storage are not satisfactorily solved. Last developments in the field of hydrogen peroxide propulsion may be found on the following Internet website: http://www.ee.surrey.ac.uk/SSC/H2O2CONF/.

U.S. Pat. No. 4,135,361 describes a closed cycle high energy density heat generating system. In the heat generating system hydrogen peroxide is fed from a vessel at a controlled rate through a catalytic converter to produce water vapor and oxygen. A first reaction heat transfer vessel receives the water vapor and oxygen mixture from the converter and combines hydrogen provided by a second reaction heat transfer with the received oxygen in a combustion reaction which produces water and heat. The water produced by the first reaction heat transfer vessel is applied to the second reaction heat transfer vessel in which it reacts with an active metal to produce a metal hydroxide, hydrogen which is recycled to the first reaction heat transfer vessel, and further heat.

### SUMMARY OF THE INVENTION

The present invention suggests a safe process and system for generating energy, which may be used for transportation applications such as car propulsion. The process and systems of the invention are based on in situ production of hydrogen from a metal, and oxidizing this hydrogen by hydrogen peroxide. Both the metal and the hydrogen peroxide that are to be used according to the present invention may be produced electrolytically, and the propulsion obtained is of zero emission, which is highly required from the environmental point of view.

According to a first aspect of the present invention there is provided a multi-step process for producing mechanical work from heat generated by two exothermic chemical reactions, one between a metal and water, carried out in a first reaction chamber to give hydrogen and heat, and the other between said hydrogen and a non-gaseous oxidizer, carried out in a second reaction chamber to give water and more heat, wherein in each step, metal is introduced to said first reaction chamber from a metal reservoir, water is introduced to said first reaction chamber from a water reservoir, and said non-gaseous oxidizer is hydrogen peroxide or a metal peroxide.

According to a second aspect of the present invention there is provided a multi-step single-chamber process for producing mechanical work from heat generated by an exothermic chemical reaction between a metal and an oxidizer in the presence of a working fluid, wherein in each step, a metal is introduced to said reaction chamber from a metal reservoir and a non-gaseous oxidizer is introduced to said reaction chamber from an oxidizer reservoir; the metal and the oxidizer being of a kind that react exothermally with each other, and the heat such produced is transferred to the working fluid by direct contact.

These two aspects of the present invention are derived from the concept of a multi-step process for producing mechanical work from heat generated by at least one exothermic chemical reaction, wherein in each step, at least part of the heat is generated by a process comprising introducing into a reaction chamber a metal from a metal reservoir and a first oxidizer from an oxidizer reservoir, the metal and the first oxidizer being of a kind that react exothermally with each other, and the first oxidizer being of a condensed phase origin.

According to another aspect of the present invention there are provided heat machines utilizing processes according to the process aspects of the invention.

One such aspect of the invention provides a heat machine comprising a first reaction chamber connected to a metal reservoir and to a condensed phase source of an oxidizer, such that metal and oxidizer may be repeatedly introduced into said reaction chamber.

The process according to the invention is termed multi-step since it includes a plurality of repetitions of a given sequence of operations, each sequence termed a step.

The way in which the metal is introduced into the reaction chamber is immaterial to the present invention. The metal may be introduced as a metal powder, as a wire, as molten metal, as metallic vapor, and in any other way known in the art per se.

In the present description and claims water may be used in the vapor phase, as superheated vapor, or may be injected directly in the liquid phase. The heat of reaction or waste heat from the system may be used for vaporization.

Hydrogen peroxide can be supplied as liquid, vapor, or can be decomposed prior to feeding by heat or catalytically.

Fluorocarbons can be used as solid, as a melt, as a coating on a metal powder or wire or after being vaporized prior to application using waste heat.

In all cases where a working fluid recycled after expansion is a substance is fed from a low-pressure zone to a high-pressure zone, a pump or compressor is introduce to overcome the pressure difference.

The term oxidizer of a condensed phase origin is to be construed as an agent that is in a condensed phase (i.e. liquid, solid, solute in a liquid solution, etc.) or that was obtained in situ from a material in a condensed phase. According to a preferred embodiment of the present invention the reaction chamber wherein hydrogen is oxidized is a cylinder of an engine. According to another preferred embodiment of the present invention, the reaction chamber in which hydrogen is oxidized is a combustor, used for operating a turbine.

Preferably, in each step, the entire amount of metal introduced in the reaction chamber is oxidized. Working in these conditions also allows controlling the temperature by introducing into the chamber an amount of water which absorbs heat, without reacting to produce heat, since the entirety of the metal has reacted with the first oxidizer. Part of the heat is contained in the metal oxide or hydroxide product, and is transferred to the incoming water by direct-contact heat exchange. In a preferred embodiment of the present invention the first oxidizer is water, and it is present in excess, such that part of the water serves to oxidize the metal and the rest serves to absorb heat so as to become steam. This steam may be used as a working fluid obviating the need to use a heat exchanger. Such a direct contact system is known in the art to be much more efficient than a system involving a heat exchanger. Furthermore, heat absorption by the excess water helps in controlling the temperature in the reaction chamber and prevents it from reaching undesirably high values. Such undesirable overheating may occur if all the heat produced by the reaction between the water and the metal is distributed only between the reaction products, which are hydrogen and metal oxide or hydroxide.

According to this embodiment, the metal oxidation produces not only heat but also hydrogen, which is preferably oxidized by an oxidizer of a condense phase origin to produce more heat and water. This reaction may also be carried out in the presence of excess water, such that the excess water is used to control the temperature in the reaction chamber. The use of excess water for oxidizing the hydrogen may have a further benefit of stabilizing the oxidizer, which generally tends to be explosive. An example for such a case is the use of a 20-50% aqueous solution of hydrogen peroxide, preferably 20-40% (w/w) as the condensed phase oxidizer. Such a solution is much more stable than concentrated (or pure) hydrogen peroxide, which tends to explode.

According to one embodiment of the present invention the oxidation of the metal and the oxidation of the hydrogen are carried out in separate reaction chambers.

Water may be added to any one of the reaction chambers even if it does not have to react, but is used only as means for controlling the temperature and/or as a working fluid.

Monatomic gases may also be used as working fluids, and they may be preferable due to their higher efficiency in heat conduction. According to the invention, the monatomic gas is used as a working fluid and obtains the heat by direct-contact with the reactants, since they are neither produced nor consumed in the process of the invention, and they should be cooled, collected and recycled after expansion. An arrangement for using monatomic gas and a bulky indirect heat exchanger, which is much less effective, is described in U.S. Pat. No. 4,135,361, which provides a system using monatomic gases to conduct heat in a combined cycle, but without using a process according to the present invention.

When the process of the invention is used to operate a turbine, and the working fluid carries with it heat that was not used in its expansion, this heat may be used further as an energy source for a bottoming cycle. This may be achieved by allowing the hot working fluid to condense and further cool, as to form gradients of pressure and temperature that may be used to operate a gas turbine. The use of such a bottoming cycle is made possible in a process according to the invention thanks to the absence of non-condensable gases in the reaction mixture. If such non-condensable gases are present, such as when hydrogen is oxidized with air, they interfere with the required further condensation and cooling.

According to another embodiment, the heat of the condensed working fluid is used to heat steam through a heat exchanger, to be used in a steam turbine.

Metals that are typically used in the process of the invention are alkali metals, alkaline-earth metals, zinc, and other metals with relatively high energy density such as aluminum and boron. Some considerations for preferring a certain metal for a specified application may be the energy density of the metal (which favors aluminum and boron) safety considerations, metal availability, cost, and convenience of regeneration.

Non-limiting examples of condensed phase oxidizers suitable for use in the process of the invention are water; peroxides, particularly hydrogen peroxide, its aqueous solution, and metal peroxides such as barium peroxide and strontium peroxide; and compounds that include fluorinated hydrocarbons, such as Teflon and other perfluorinated hydrocarbons, partially fluorinated hydrocarbons and mixed fluorine-chlorine carbonaceous compounds. The use of fluorine compounds as condensed phase oxidizers requires that the process/system include means for removal of the side-products in a way that does not interfere with the turbine, engine, or thermodynamic cycle.

As mentioned, according to one embodiment of the invention the condensed phase source for the oxidizer is a metal peroxide, preferably barium, strontium, or lithium peroxide.

Barium peroxide when heated with water, will release hydrogen peroxide. At relatively high temperature, of around 600° C, the hydrogen peroxide is decomposed, such that the products of the reaction are metal hydroxide and oxygen. Either oxygen or hydrogen peroxide may be used as an oxidizing agent to oxidize the hydrogen in a process according to the invention, but preferably, the barium peroxide is heated with the water to a temperature where oxygen is produced.

Metal peroxide may be in situ regenerated from metal hydroxide or from metal oxide by reacting the hydroxide or the oxide with atmospheric air. This reaction allows for rejection of nitrogen, and the entire process allows the use of atmospheric oxygen for oxidizing hydrogen to operate a heat machine without producing nitrogen-oxides. In such an embodiment, carbon dioxide from the air might react with the metal to form a barium carbonate. To prevent poisoning of the system with carbonate, it may be useful to heat it to high enough a temperature, in which the carbon dioxide is released from the carbonate. Reacting the barium peroxide with hydrogen and water together may produce the desired high temperature and prevent the formation of a carbonate altogether, while oxidizing the hydrogen to operate the process of the invention.

These reactions may be utilized to power several novel heat machines. In one such machine, BaO is used to clean air from nitrogen. Accordingly, BaO is exposed to air at a first temperature, T₁, which favors the production of the metal peroxide BaO₂, and the nitrogen from the air is rejected. Then, the temperature is increased to a second temperature, T₂, at which the metal peroxide releases oxygen, and this oxygen is used as an oxidizer of condensed phase origin according to the invention. The heat required for increasing the temperature from T₁ to T₂ may be taken from the heat produced by the oxidation of the metal fuel, or, in cases where hydrogen is also oxidized, from the heat produced from oxidation of hydrogen.

In another such machine, BaO₂ is reacted with steam to provide an oxidizer. In such machine, BaO₂ is exposed to steam to produce barium oxide or hydroxide and oxygen or hydrogen peroxide. The oxygen or hydrogen peroxide are then used as oxidizers of condensed phase origin, in accordance with the present invention. The metal peroxide BaO₂, used as a starting material in this machine, may be generated either from the metal oxide or from the metal hydroxide by reacting them with oxygen, for example from ambient air, as explained above.

In the machines described above, ambient air is used as an oxygen source. This is extremely advantageous over using tanks of pure oxygen, as was suggested in the prior art, and even over using tanks of hydrogen peroxide solution, according to some embodiments of the present invention.

In all the above regeneration processes, carbon dioxide, which is present in the air, may react with the metal hydroxide to form a metal carbonate, which should be rejected from the system. The formation of carbonate may be dealt with by reacting it with steam or decomposing it at a high enough temperature. In order to work in conditions with no net formation of carbonate, it is possible to react a metal (Ba or Sr) peroxide with steam and hydrogen that were formed in the reaction of the metal fuel (e.g. Mg) and water. Hydrogen reacts with the peroxide to give water and metal oxide, and this oxide reacts with steam to produce metal hydroxide. The conditions of the reaction will form enough heat so as to prevent the net formation of a carbonate, while allowing the use of the steam as a working fluid.

In the context of the present invention barium and its compounds may be replaced by strontium or calcium and their respective compounds, to give similar reactions, even if under somewhat different conditions.

Preferable processes according to the invention are those that allow a closed system operation with no emission. One further advantage of the process of the invention is that it makes use of metals that may be produced by environmentally friendly processes, which do not emit pollutants to the environment. Additionally, the production of metals such as those useable in the present invention may be carried out at off-peak hours, by electrolysis for example, to consume over-production, and these metals may be consumed for operating turbines and engines according to the present invention. Not only that, but hydrogen peroxide is known to be produced by electrolytic decomposition of water. Therefore, it is important to note, that as metal can be produced by the cathodic reduction of metal compounds, hydrogen peroxide may be produced by anodic oxidation through the intermediate formation of peroxydisufuric acid or other acids. Thus, there is provided according to the present invention a process for obtaining a metal and hydrogen peroxide by elelctrolitically anodic oxidation of water, said anodic oxidation being electrically conjugated with cathodic reduction of a metal compound. Similarly, there is provided by the present invention an electrolysis cell comprising an anodic half cell in which hydrogen peroxide is produced and a cathodic half cell in which metal is produced. Consequently, metal and hydrogen peroxide may be produced in one stage, i.e. in one electrolytic process the metal can be produced at the cathode and the hydrogen peroxide at the anode, saving cost and energy.

Finally, there is provided by the present invention a method for operating an internal combustion engine comprising: (a) introducing into a reaction chamber, in each cycle of the engine, a predetermined amount of metal and a predetermined amount of water to produce hydrogen and steam, (b) delivering said hydrogen and steam to the engine cylinder, and (c) combusting said hydrogen inside said cylinder with oxygen. The amount of water introduced into the reaction chamber is determined such that a portion of the water reacts with the entire predetermined amount of metal to produce hydrogen and heat, and the rest of the water is heated by said heat to a predetermined temperature, at which the steam enters the cylinder of the engine. Preferably, this temperature is of between about 300° C. and about 1200° C., most preferably about 400-700° C. The reaction chamber should be separated from the cylinder, to ensure that the cylinder is protected from the metal oxide created in the reaction chamber, since such metal oxides might be very erosive.

The oxygen in (c) may be of condensed phase origin or of gaseous origin, particularly ambient air.

In case an oxidizer of condensed phase origin is preferred, it may be advantageous to use metal peroxide as an oxidizer source, and react it with a portion of the steam produced in (b) to give oxygen that is introduced into the engine cylinder. The metal peroxide may be BaO₂ or other peroxides that may be regenerated in situ as explained above. Another preferred embodiment is to use peroxide of metal that cannot be regenerated in situ, but has very high oxidizing power per unit weight, such as lithium.

### BRIEF DESCRIPTION OF THE DRAWINGS

In order to understand the invention and to see how it may be carried out in practice, several embodiments will now be described, by way of non-limiting examples only, with reference to the accompanying drawings, in which:

FIGS. 1-7 are schematic illustrations of seven different embodiments of the present invention;

FIG. 8 is a graph illustrating the equilibrium molar relationships between BaO, BaO₂, steam, and oxygen under specified conditions; and

FIG. 9 is a graph illustrating the equilibrium molar relationships between BaO₂, Ba(OH)₂, H₂O and O₂, under specified conditions.

In the drawings, parts of the same function are referred with numerals having the same two digits.

### DETAILED DESCRIPTION OF THE DRAWINGS

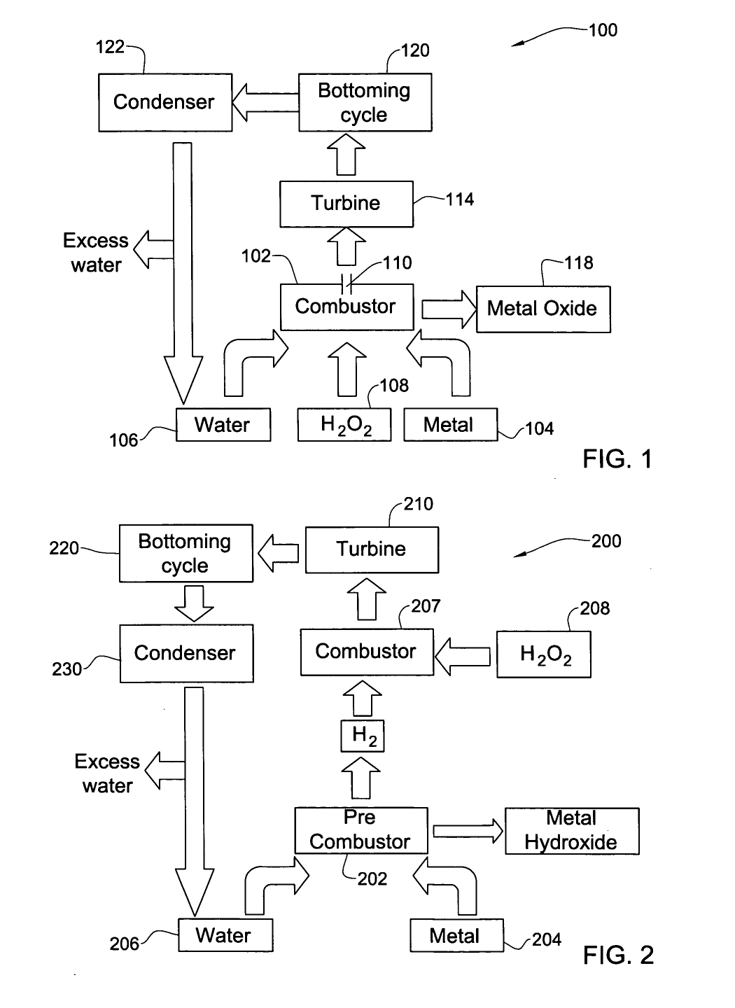

FIG. 1 illustrates one embodiment of the present invention, according to which there is provided a heat machine 100 comprising a combustor 102 connected to a metal source 104, a water source 106, and a hydrogen peroxide source 108, such that metal, water, and hydrogen peroxide may be introduced into the combustor 102 in a controlled manner. Required valves and pumps are not shown in the figure for the sake of simplicity, but choosing and placing them in the machine 100 is a straightforward task for a person skilled in the art. The combustor 102 has a nozzle 110, through which steam may expand towards a turbine 114 thereby producing useful energy. In operation, water coming from the water source 106 reacts in the combustor 102 with metal coming from the metal source 104 to produce hydrogen, heat, and metal oxide 118.

To control the temperature, additional water (beyond the amount required to react with the metal) is injected into the combustor 102 from the water source 106. This additional water is converted to steam, thereby absorbing some of the heat produced by the exothermic reaction of the metal with the water.

It should be noted that as the water is injected into the combustor 102 in the liquid phase, a very small amount of work is required, while a significant increase in pressure is achieved due to the evaporation of this water in the combustor. This pressure increase, obtained with little work consumption, is one of the advantages of the present embodiment over classic heat machines, where air is compressed by a compressor before fuel is introduced therein.

Next, hydrogen peroxide, or a solution thereof, from source 108 is added to the hot mixture of hydrogen and steam present in the combustor 102. The peroxide reacts with the hydrogen to produce water and additional heat, and the pressure and temperature in the combustor 102 rises even more.

A valve (not shown) is opened to allow the steam to expand through nozzle 110 into the turbine 112. In this expansion the steam is cooled somewhat, but it still may carry with it enough heat to power a bottoming cycle 120, such as a gas turbine (if the quality of the steam is high enough) or a heat exchanger. Downstream of the bottoming cycle 120 is a condenser 122 wherein remaining steam, if any, is condensed. Water from the condenser 122 is pumped back to the water source 106, such that no material is emitted from the system, except for excess water and the metal oxide 118, from which metal may be regenerated, albeit not in situ, as discussed in the summary section of this specification.

The metal oxide 118, as any other solid product produced during the operation of a process according to the invention, may be removed by methods known in the art per se, such as filtering out the metal oxide or rotating the combustor 102 to create centrifugal forces by which the metal oxide 118 may be separated from the working fluid. A similar effect may be achieved by imparting a spiral configuration to the flow of working fluid.

FIG. 2 illustrates another heat machine 200 according to the present invention. The machine 200 comprises a pre-combustor 202, connected to a metal source 204, and a water source 206 to receive therefrom metal and water. Pre-combustor 202 is also connected to a combustor 207, such that the combustor may be fed by a hydrogen coming from the pre-combustor. The combustor 207 is connected to a hydrogen peroxide source 208 to receive therefrom hydrogen peroxide or a solution thereof, and downstream of the combustor there is a turbine 210, which is powered by steam generated in the combustor. Downstream of the turbine 210 is a bottoming cycle 220, such as a turbine or heat exchanger followed by a condenser 230, connected also to the water source 206, such that water condensed in the condenser may be returned to the water source.

In operation, metal, coming from the source 204 and water (typically in excess), coming from the source 206 react in the pre-combustor 202 to produce hydrogen, steam and metal hydroxide. The metal hydroxide is rejected, either as a solid or a solution, while the hydrogen is fed into the combustor 207 together with hydrogen peroxide solution, introduced from the source 208. In the combustor 207 the hydrogen and the hydrogen peroxide react to form high-temperature steam. Now the combustor 207 has steam from three sources: the oxidation of hydrogen, which took place within the combustor 207; heating of water from the hydrogen peroxide solution by the heat produced during said oxidation; and steam created in the pre-combustor 202, due to the excess water used for metal oxidation therein. The steam in the combustor 207 then flows into the turbine 210, the bottoming cycle 220, the condenser 230 and back to the water source 206, as in the embodiment described in relation to FIG. 1.

The concentration of hydrogen peroxide solution used for the oxidation of hydrogen can be determined according to the amount and temperature of steam required for operating the turbine 210. It is also possible to connect the combustor 207 to the water source 206 in order to allow water addition to the combustor 207, which is independent on the concentration of the hydrogen peroxide solution.

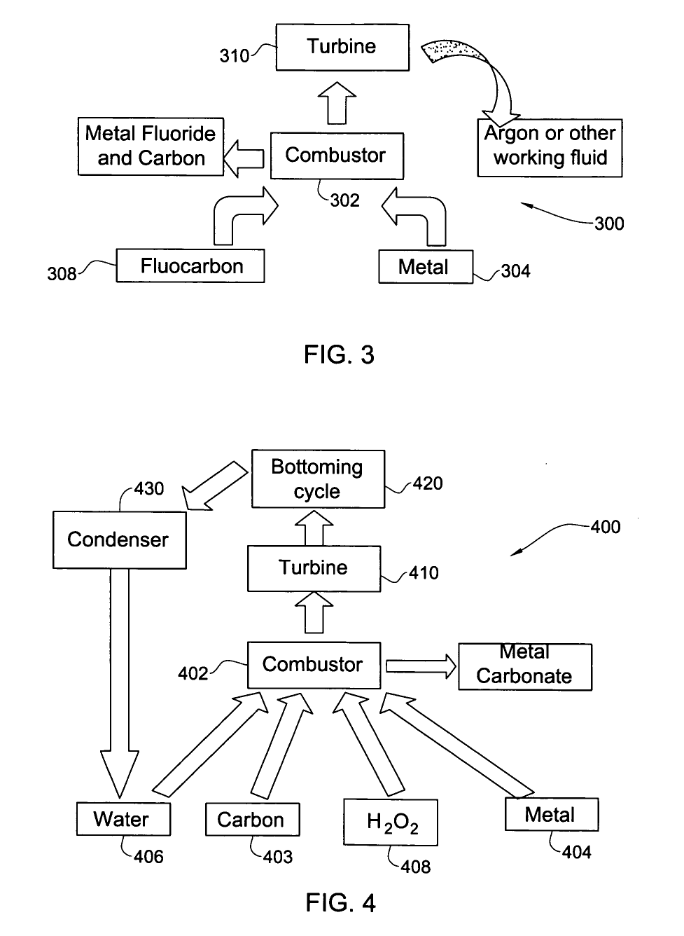

FIG. 3 shows another heat machine 300 according to the invention. The machine 300 uses metal 304 as its fuel and a fluorocarbon compound 308 as an oxidation agent. Equivalent amounts of the metal and the fluorocarbon compound 308 are introduced into the combustor 302 to form metal fluoride and carbon, which are rejected from the cycle. Simultaneously, a monatomic working fluid, such as argon, is added from a working fluid source 309 to the combustor 302. The working fluid is heated in the combustor 302 by the heat generated by the exothermic reaction between the metal and the fluorocarbon and expanded through a turbine 310 to produce power.

FIG. 4 presents a machine 400, which is a modification of the embodiment of FIG. 1. According to this modification, metal fuel together with carbon or any carbonaceous material are oxidized by hydrogen peroxide to form metal carbonate as final solid product that has to be rejected. For the sake of simplicity, the sequence of introducing the reactants is not presented in detail. Since some metals tend to from carbides when heated together, it may be advantageous to oxidize the carbon and the metal in separate compartments, to form metal hydroxide and CO₂, and only later to let the metal hydroxide and the carbon dioxide react together to produce a metal carbonate. The working fluid is steam that absorbs heat in the different steps and eventually is fed to the turbine to produce energy. Such a system have the advantage that it may use fuels of low degree, that if supplied to conventional engines, exhaust CO₂, sulfur, lead, and other pollutants, while in the present embodiment, these pollutants react with the metal to form solid end products that are rejected, and not exhausted into the atmosphere.

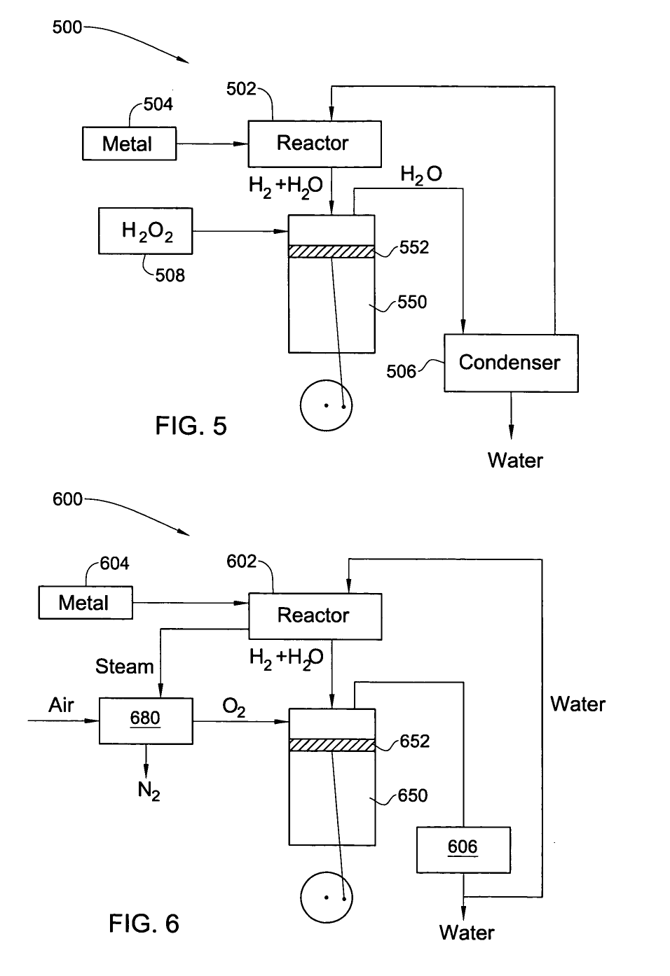

FIG. 5 represents another heat machine 500 in accordance with the present invention. The machine 500 is an internal combustion reciprocating steam engine comprising a reactor 502, connected to a metal source 504 and to a water reservoir 506, to allow the reaction of metal with water in the reactor. The reactor 502 is also connected to a cylinder 550, which is being connected to a hydrogen peroxide source, 508 and to the water reservoir 506, such that upon combustion of hydrogen with hydrogen peroxide in the cylinder 550 to produce steam, the steam expands to move a piston 552, thereby partly condensing and leaving the cylinder back to the water reservoir 506 through condenser contained therein. The said movement of the piston 552 is used for producing useful energy, and the piston may then be brought back to its initial position against the pressure of the condensed water in the cylinder, which is very low. Valves allowing the continuous operation of the engine are provided, opened and closed as required, as well known in the art of engineering.

FIG. 6 illustrates a heat machine 600 similar to that illustrated in FIG. 5, only here, hydrogen peroxide source is not needed, since ambient air is used to oxidize the hydrogen in the cylinder 650. In order not to form N-oxides, that may be formed if hydrogen is reacted with air, the air goes first through a barium oxide reservoir 680, where it is reacted to give barium peroxide. The nitrogen is discharged. Then steam is produced via a heat exchanger in the reaction chamber 602 and allowed to enter to the reservoir 680, where barium peroxide reacts to release oxygen, and the oxygen is pumped into the cylinder 650, where it reacts with hydrogen coming in from the reactor 602.

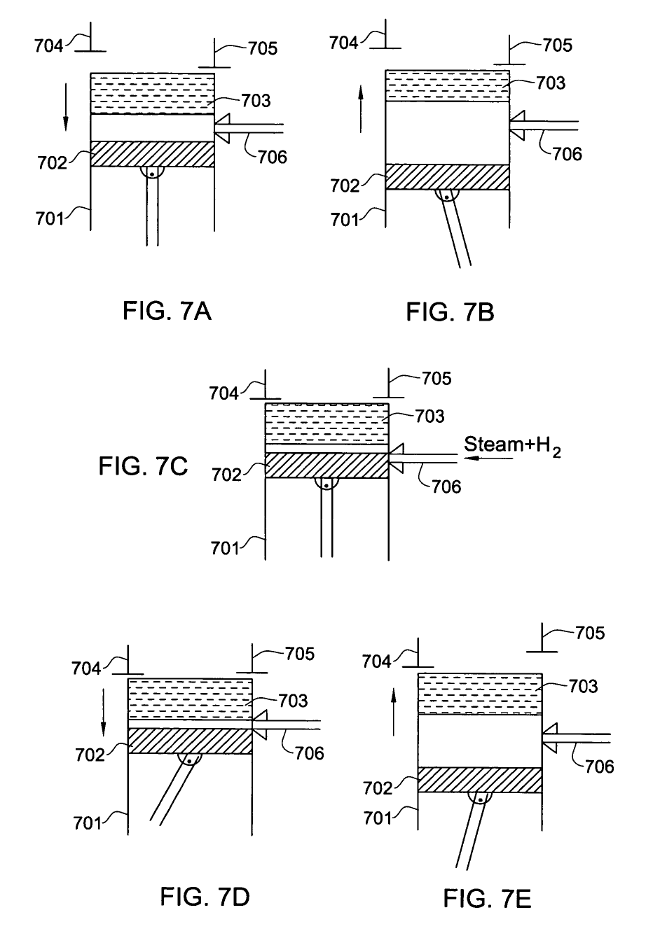

FIGS. 7A to 7E describe the cyclic operation of a four-tact reciprocating engine cylinder 701 (corresponding to the cylinder 650 of FIG. 6), where the barium oxide reservoir 680 is replaced with a barium oxide/barium peroxide porous filter 703, being an integral part of the cylinder 701. Parts shown in these figures, and the numerals referencing them are:

| | |
|---|---|
| The cylinder | 701; |
| A piston | 702; |
| The barium oxide/peroxide porous filter | 703; |
| An air valve | 704; |
| A steam valve | 705; and |
| An injector of steam and hydrogen | 706. |

FIG. 7A illustrates an air-intake tact, in which ambient air is sucked through air valve 704 by the down movement of the piston 702, and passes through the barium oxide/peroxide porous filter 703, which absorbs the oxygen from the air (by reacting with it to form barium peroxide) and lets the nitrogen pass into the cylinder.

FIG. 7B illustrates the nitrogen rejection tact, in which nitrogen is blown-off from the cylinder 701 through valve 704 by the upwards movement of the piston 702. In case cylinder 701 had in it some oxygen, it is “trapped” on the filter 703.

FIG. 7C illustrates the injection phase, in which a mixture of hydrogen and steam at moderate pressure, of typically 10 Atm, are injected into the cylinder 701 through the steam injector 706, while valves 704 and 705 are closed. The steam releases the oxygen from the barium oxide filter, and the released oxygen reacts with the injected hydrogen to form water. The oxidation of hydrogen with oxygen is exothermic enough to turn all the water in the cylinder to steam, as the pressure and temperature raises to about 100 Atm and 1000 C.

FIG. 7D illustrates the expansion tact, that may also be termed the work production cycle. The steam in the cylinder 701 moves the piston 702 downwards (the valves 704 and 705 are still closed), such that the expansion ratio is about 1:100, and the steam approaches condensation.

FIG. 7E illustrates the evacuation tact, in which upwards movement of piston 702 pushes the expanded steam through valve 705 (now opened) to a condenser (606 in FIG. 6), where it condenses to liquid water, and moves on to the reaction chamber 602.

FIG. 10 represents another heat machine 1000 in accordance with the present invention. The machine 1000 is an internal combustion reciprocating steam engine comprising a reactor 1002, connected to a metal source 1004 and to a water reservoir 1006, to allow the reaction of metal with water in the reactor. The reactor 1002 is also connected to a cylinder 1050, which is being connected to an oxygen source 1008 and to the water reservoir 1006, such that upon combustion of hydrogen with oxygen in the cylinder 1050 to produce steam, the steam expands to move a piston 1052, and leaves the cylinder back to the water reservoir 1006 through condenser contained therein. The said movement of the piston 1052 is used for producing useful energy, and the piston may then be brought back to its initial position against the pressure of the condensed water in the cylinder, which is very low.

FIG. 11 illustrates a heat machine 1100 similar to that illustrated in FIG. 10, only here, lithium peroxide functions as a condensed phase source for oxygen. Then steam is produced via a heat exchanger (not shown) in the reaction chamber 1102 or in the water condenser of the water reservoir 1106 and allowed to enter to the oxygen source 1185, where lithium peroxide reacts with the steam to release oxygen, and the oxygen is pumped into the cylinder 1150, where it reacts with hydrogen coming in from the reactor 1102.

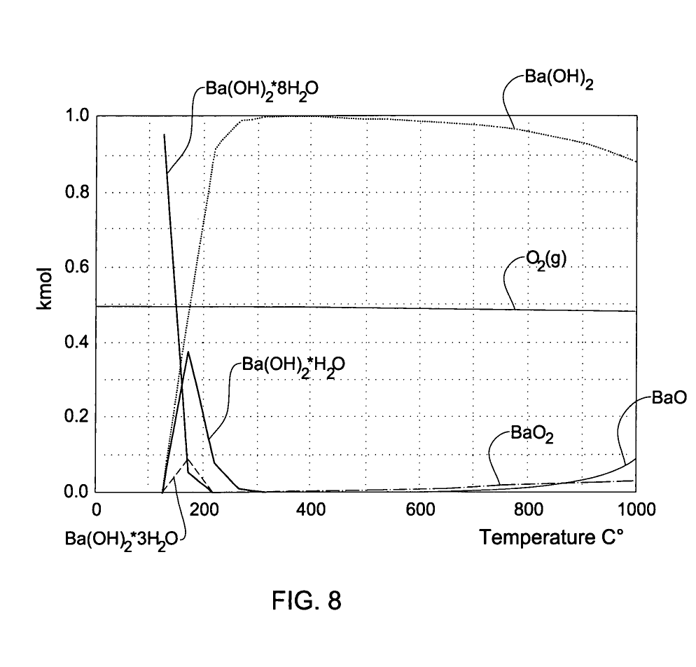

FIG. 8 illustrates the relationships for the system BaO, BaO₂, steam, and oxygen, at equilibrium, under pressure of 10 atmospheres and starting with BaO₂ and a 10 fold excess of steam. The X axis represents temperature (in ° C.), and the Y axis represents number of moles of each of the constituents of the system.

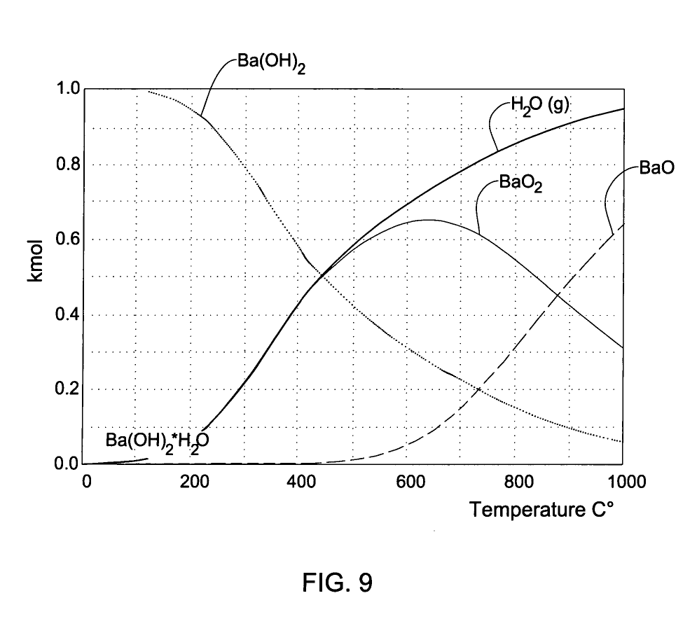

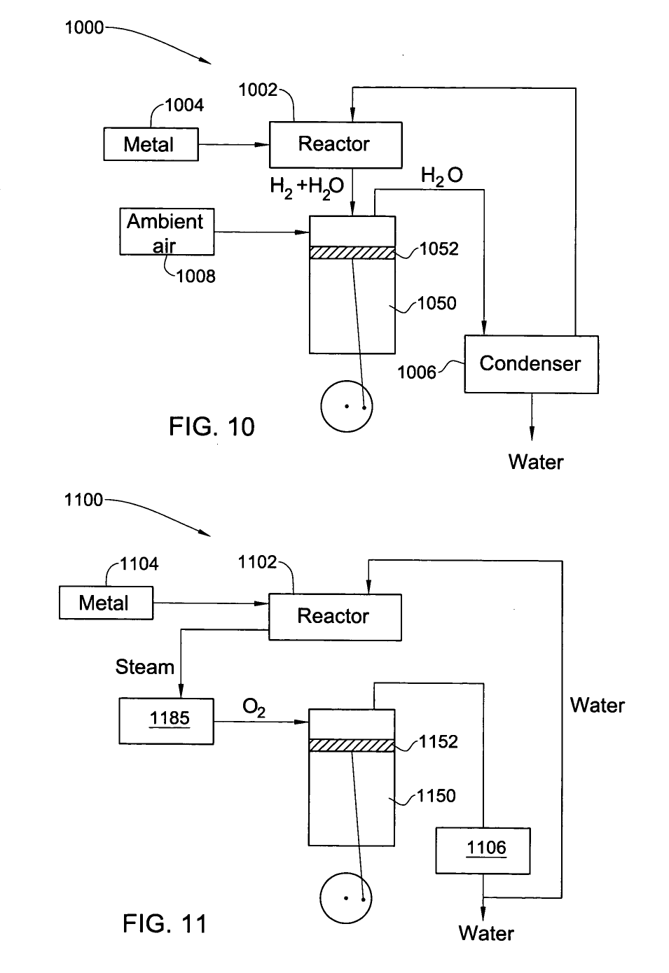

FIG. 9 illustrates the relationships for the system BaO₂, Ba(OH)₂, and O₂, with excess oxygen, starting with Ba(OH)₂. The meaning of the X and Y axis are as in FIG. 8.

The graphs of FIGS. 8 and 9 were obtained using the commercially available computer program Outokumpu HSC Chemistry for Windows 5.1.

As may be inferred from FIG. 9, around 450° C. the equilibrium conditions between barium oxide, barium hydroxide, oxygen and water are such that at excess water barium hydroxide and oxygen are formed, while at excess oxygen, barium peroxide and water are formed. This may be utilized to form oxygen and to regenerate barium peroxide according to some of the embodiments of the present invention.

1. A multi-step process for producing mechanical work from heat generated by two exothermic chemical reactions, one between metal and water, carried out in a first reaction chamber to give hydrogen and heat, and the other between said hydrogen and an oxidizer, carried out in a second reaction chamber to give water and more heat, wherein in each step, a metal is introduced to said first reaction chamber from a metal reservoir, water is introduced to said first chamber from a water reservoir, and said oxidizer is oxygen of ambient air or is of a condensed phase origin.

2. A process according to claim 1, wherein said second reaction chamber is a cylinder of a reciprocating engine.

3. A process according to claim 1, wherein said second reaction chamber is a combustor used for operating a turbine.

4. A process according to claim 1, wherein in each step the entire amount of the metal introduced is reacted in said reaction.

5. A process according to claim 1, wherein said oxidizer is of a condensed phase.

6. A process according to claim 1, wherein said oxidizer is a gas obtained in situ from a source that is capable of being regenerated in situ.

7. A process according to claim 5, wherein said oxidizer is liquid hydrogen peroxide.

8. A process according to claim 1, wherein said condensed phase origin comprises metal peroxide, metal oxide, metal hydroxide, or a combination thereof.

9. A process according to claim 8, wherein said metal is selected from calcium, barium, strontium and lithium.

10. A process according to claim 1, wherein water introduced into said first reaction chamber is of an excess amount over said metal.

11. A process according to claim 1, wherein further introduced into said second reaction chamber in each step is an amount of water.

12. A process according to claim 10, wherein the water that is in excess amount over said metal is introduced as liquid water.

13. A process according to claim 1, wherein said oxidizer is hydrogen peroxide in an aqueous solution.

14. A process according to claim 13 wherein said aqueous solution is of a concentration of 50% (w/w) or less.

15. A process according to claim 14 wherein said concentration is between about 20% and about 40%.

16. A process according to claim 1, wherein said mechanical work is powering a turbine and a bottoming cycle.

17. A process according to claim 16, wherein said bottoming cycle is a gas turbine.

18. A process according to claim 16, wherein said bottoming cycle is a Rankine cycle.

19. A process according to claim 1, wherein said metal is selected from the group consisting of alkali metals, alkaline-earth metals, zinc, aluminum and boron.

20. A process according to claim 19, wherein said metal is selected from aluminum, zinc, boron, calcium and magnesium.

21. A process according to claim 6, wherein said oxidizer is metal peroxide.

22. A process according to claim 21, wherein said metal peroxide is barium peroxide, calcium peroxide, or strontium peroxide.

23. A process according to claim 1, wherein said oxidizer is oxygen produced in situ by a method comprising heating a metal peroxide, the metal being barium, strontium, lithium or calcium.

24. A process according to the preceding claim 23, wherein said metal peroxide is obtained in situ by a process comprising exposing a metal hydroxide to air comprising oxygen and nitrogen at a predetermined temperature, such that oxygen from the air reacts with the metal hydroxide to produce metal peroxide.

25. A process according to claim 1, wherein said oxidizer is hydrogen peroxide or oxygen obtained in situ from a reaction of metal peroxide with steam to produce metal oxide or hydroxide and hydrogen peroxide or oxygen, said metal being barium, strontium, or calcium.

26. A process according to claim 3, wherein in said second reaction chamber hydrogen is reacted with metal peroxide in the presence of steam, said metal being barium, calcium, lithium or strontium.

27. A process according to claim 23, wherein said metal peroxide is generated in situ by reacting a metal oxide or a metal hydroxide with air.

28. A process according to claim 1, wherein said process is initiated by ignition of an electric spark, arc, or heat in said first and/or second reaction chamber.

29. A multi-step process for producing mechanical work from heat generated by an exothermic chemical reaction taking place in a first chamber between a metal and an oxidizer in the presence of a working fluid, wherein in each step, metal is introduced to said reaction chamber from a metal reservoir and a non-gaseous oxidizer is introduced to said reaction chamber from an oxidizer reservoir; the metal and the oxidizer being of a kind that react exothermally with each other, the heat such produced is transferred to the working fluid by direct contact, and said working fluid works to produce mechanical work in a second chamber.

30. A process according to claim 29, wherein in each step further introduced into said chamber is a carbonaceous material.

31. A process according to claim 29, wherein said oxidizer is a fluorinated hydrocarbon.

32. A process according to claim 29, wherein said oxidizer is hydrogen peroxide.

33. A process according to claim 29, wherein said working fluid is a monatomic gas.

34. A process according to claim 29, wherein said working fluid is water.

35. A process according to claim 29, wherein said first chamber is a combustor of a gas turbine.

36. A process according to claim 35, wherein after expansion through the turbine said working fluid is cooled and at least partly recycled into the reaction chamber.

37. A process according to claim 29, wherein said working fluid is used to operate a reciprocating engine with cylinder and piston.

38. A process according to claim 37, wherein after expansion through said engine, said working fluid is cooled and at least partly recycled into the reaction chamber.

39. A process according to claim 31, wherein said metal is selected from the group consisting of alkali metals, alkaline-earth metals, zinc, and aluminum.

40. A process according to claim 32, wherein said metal is selected from the group consisting of alkali metals, alkaline-earth metals, zinc, and aluminum, and boron.

41. A process according to claim 39, wherein said metal is selected from aluminum, boron, calcium and magnesium.

42. A process according to claim 29, wherein said process is initiated by ignition of an electric spark, arc, or heat in said reaction chamber.

43. A process according to claim 1, wherein there is a need for rejection of solids from a working fluid and said rejection is carried out by rotating a reaction chamber to create centrifugal forces by which said solids are separated from said working fluid.

44. A process according to claim 1, wherein there is a need for rejection of solids from a working fluid and said rejection is carried out by imparting a spiral configuration to the flow of said working fluid.

45. A heat machine utilizing a process according to claim 1.

46. A heat machine according to claim 45, comprising a reciprocating engine.

47. A heat machine according to claim 45, comprising a turbine.

48. A heat machine according to claim 45, comprised in a vehicle for its propulsion.

49. A heat machine according to claim 48, wherein said vehicle is a car.

50. A heat machine comprising a first reaction chamber connected to a metal reservoir and to a water source, such that metal and water may be repeatedly introduced into said reaction chamber to react exothermally with each other inside said first reaction chamber, and a second reaction chamber connected to said first reaction chamber to receive therefrom hydrogen and steam, said second reaction chamber being further connected to a source of an oxidizer, such that said hydrogen may exothermally react with said oxidizer.

51. A heat machine according to claim 50, further comprising dosing means for controlling the amount of metal introduced into the reaction chamber.

52. A heat machine according to claim 50, further comprising dosing means for controlling the amount of oxidizer introduced into said reaction chamber.

53. A heat machine according to claim 50, wherein said second reaction chamber is a cylinder of an engine.

54. A heat machine according to claim 53, further having a body comprising barium oxide, barium hydroxide, barium peroxide or a mixture thereof, means to enter ambient air into said body, and means to supply oxygen from said body to said cylinder.

55. A process for elelctrolitically obtaining a metal and hydrogen peroxide by anodic oxidation of water, being electrically conjugated with cathodic reduction of a metal compound.

56. An electrolysis cell comprising an anodic half cell, in which hydrogen peroxide is produced and a cathodic half cell, in which metal is produced.

57. A method for operating an internal combustion engine having a cylinder and a reaction chamber separated from said cylinder, the method comprising: (a) introducing into said reaction chamber, in each cycle of the engine operation, a predetermined amount of metal and a predetermined amount of water to produce hydrogen and steam, (b) delivering said hydrogen and steam to said cylinder, and (c) combusting said hydrogen inside said cylinder with oxygen, wherein the amount of water introduced into the reaction chamber in (a) is determined such that a portion of the water reacts with the entirety of said predetermined amount of metal to produce hydrogen and heat, and the rest of the water is heated by said heat to a temperature of between 300° C. and 1200° C.

58. A process according to claim 57, wherein said temperature is preferably between 400° C. and 700° C.

59. A method according to claim 57, wherein said oxygen is of ambient air.

60. A method according to claim 57, wherein said oxygen is provided from a condensed phase source.

61. A method according to claim 60, wherein said source comprises metal peroxide, metal oxide, metal hydroxide, or a combination thereof.

62. A method according to claim 61, wherein said metal is selected from calcium, barium, strontium.

63. A method according to claim 61, wherein said source is lithium peroxide.

64. A method according to claim 61, wherein said source is metal peroxide, and said metal peroxide is reacted with a portion of the steam produced in (a) to give oxygen that is introduced into the engine cylinder.

65. A method according to claim 64, wherein said metal peroxide may be regenerated in situ.

66. A method according to claim 65, wherein said metal peroxide is barium peroxide.

67. A method according to claim 64, wherein said metal peroxide is lithium peroxide.

68. A process according to claim 29, wherein said second chamber is a cylinder of a reciprocating engine.

69. A process according to claim 29, wherein said second chamber is a turbine.

70. A process according to claim 61, wherein said source is metal peroxide, and said metal peroxide is reacted with steam heated with heat produced in (a) to give oxygen that is introduced into the engine cylinder.

71. A process according to claim 72, wherein said metal peroxide is reacted with steam in the presence of hydrogen, said hydrogen and a portion of said steam being produced in (a).

72. A heat machine utilizing a process according to claim 29.

73. A process according to claim 64, wherein said source is metal peroxide, and said metal peroxide is reacted with steam heated with heat produced in (a) to give oxygen that is introduced into the engine cylinder.
